(19) United States
(12) Patent Application Publication
(10) Pub. No.: US 2014/0132501 A1
(43) Pub. Date: May 15, 2014

(54) METHOD AND APPARATUS FOR PROJECTING PATTERNS USING STRUCTURED LIGHT METHOD

(71) Applicant: Electronics and Telecommunications Research Instit ute, Daejeon (KR)

(72) Inventors: Seung Min CHOI, Daejeon (KR); Jae Il CHO, Daejeon (KR); Dae Hwan HWANG, Daejeon (KR)

(73) Assignee: Electronics and Telecommunications Research Instit ute, Daejeon (KR)

(21) Appl. No.: 14/016,660

(22) Filed: Sep. 3, 2013

(30) Foreign Application Priority Data
Nov. 12, 2012 (KR) 10-2012-0143227

(51) Int. Cl. G06F 3/01; G01B 11/25

(52) U.S. Cl. CPC G06F 3/017; G01B 11/254
USPC 345/156; 356/610

(57) ABSTRACT

This specification provides a method of projecting patterns using a structured light method and a stereo vision apparatus using the same. The apparatus includes a Laser Diode (LD), an optical splitter configured to receive a light source from the LD and copy a plurality of light sources having identical characteristics with the light source of the LD, and a plurality of diffusers configured to receive the plurality of light sources copied by the optical splitter and optically project patterns.

Priority to Korean patent application number 1 0-201 2-01 43227 filed on Dec. 11, 2012, the entire disclosure of which is incorporated by reference herein, is claimed.

### BACKGROUND OF THE INVENTION

1. Field of the Invention

The present invention relates to pattern projection and, more particularly, to 3-D stereo vision using structured light.

2. Discussion of the Related Art

A human visual system is known to obtain distance information by properly matching two images obtained at different locations. Stereo matching is one of visual fields for automating the distance extraction ability of the human visual system. This stereo matching method is being widely used in medical images, factory automation, and map production because this method is more effective than a method of measuring the distance as a function of the traveling time and speed of light using ultrasonic waves and a laser as light sources and is also less limited by real application environments. A basic step for obtaining distance information can include the acquisition of an image, the extraction of characteristics, stereo matching, disparity estimation, and the calculation of the distance from a disparity.

Active research is being carried out in order to use a human's gesture as an input device, such as a keyboard, a remote controller, and a mouse, by detecting a human's gesture using 3-D information and associating the 3-D information according to a control command for an apparatus.

Techniques for a variety of input devices using a human's gesture are invented and being used in real life. For example, the techniques include the recognition of a gesture (e.g., Nintendo Wii) using an attachment type haptic device, the recognition of a gesture (e.g., an electrostatic type touch screen by iPAD of Apple) using a contact type touch screen, and near-field contactless gesture recognition within several meters (e.g., Kinect device of XBOX by Microsoft).

In particular, an example in which a 3-D scanning method using existing machine vision with high precision used in military purposes or factory automation is applied to common applications is the Kinect device. The Kinect device is a real-time 3-D scanner for projecting a laser pattern having class 1 onto a real environment, detecting information about a visual distance in each distance that is generated between a projector and a camera, and converting the detected information into 3-D frame information. The Kinect device was commercialized by Microsoft Co. using technology invented by Primesense Co. of Israel.

The Kinect device is one of the best-selling 3-D scanner products that can be used without a safety problem for a user so far. A 3-D scanner having a similar form to the Kinect device and derivatives using the Kinect device have been developed.

The present invention proposes a structure for developing a 3-D scanning product using a structured light method, such as the Kinect device. In particular, the present invention proposes a 3-D stereo vision apparatus using structured light, from among machine vision techniques, and proposes a pattern projection method in which the occurrence of distortion in pattern projection in obtaining the 3-D of a wide field of view can be minimized and low cost and low power can also be taken into consideration and a stereo vision apparatus using the pattern projection method.

### SUMMARY OF THE INVENTION

An object of the present invention is to provide a 3-D pattern projection method having a field of view of a pattern expanded using structured light.

Another object of the present invention is to provide a stereo vision apparatus using pattern projection.

In accordance with an aspect of the present invention, a stereo vision apparatus includes a Laser Diode (LD), an optical splitter configured to receive a light source from the LD and copy a plurality of light sources having the same characteristics as the light source of the LD, and a plurality of diffusers configured to receive the plurality of light sources copied by the optical splitter and optically project patterns.

Each of the plurality of diffusers may include a Diffraction Optical Element (DOE) or a speckle pattern element.

The stereo vision apparatus may further include a pattern matching unit configured to control or compensate for the intensity of the light source lost in the optical splitter.

The output ports of the optical splitter may be made of glass fiber.

In accordance with another aspect of the present invention, a method of a stereo vision apparatus projecting patterns includes receiving a light source from a Laser Diode (LD), copying a plurality of light sources having the same characteristics as the light source of the LD, and optically projecting patterns based on the copied light sources.

In accordance with yet another aspect of the present invention, a stereo vision matching apparatus includes a pattern projector configured to include a Laser Diode (LD), an optical splitter for receiving a light source from the LD and copying a plurality of light sources having the same characteristics as the light source of the LD, and a plurality of diffusers for receiving the plurality of light sources copied by the optical splitter and optically projecting patterns onto a subject, a plurality of stereo cameras configured to photograph the patterns projected on the subject, and a stereo matching unit configured to generate a depth map by performing stereo matching based on the photographed results.

In accordance with further yet another aspect of the present invention, a stereo vision matching method includes receiving a laser light source, copying a plurality of light sources having the same characteristics as the laser light source, receiving the plurality of copied light sources, optically projecting patterns onto a subject, photographing the patterns projected on the subject using a plurality of stereo cameras, and generating a depth map by performing stereo matching based on the photographed results.

### BRIEF DESCRIPTION OF THE DRAWINGS

FIG. 1 shows an example of a conceptual diagram of stereo matching using a structured light method to which the present invention is applied;

FIG. 2 shows an example of a method of projecting a pattern using a structured light method;

FIG. 3 shows another example of the method of projecting patterns using a structured light method;

FIG. 4 shows an example of a stereo vision apparatus using a structured light method in accordance with the present invention;

FIG. 5 shows an example of a stereo matching apparatus for matching a wide angle pattern in accordance with the present invention; and

FIG. 6 shows an example of a stereo matching method for matching a wide angle pattern in accordance with the present invention.

### DETAILED DESCRIPTION OF THE EMBODIMENTS

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

A stereo matching method using stereo vision is a method of calculating speed of an object from a movement of the object photographed by a stereo camera or extracting disparity information from images captured by two stereo cameras in real time. The disparity information obtained by the stereo matching method can be used as a criterion for recognizing and determining an object.

Or, stereo vision can mean a visual system configured to recognize the distance using two cameras and to function as a human eye or can mean a method of measuring the distance of an object using a pair of cameras according to a computer image scheme.

Some basic terms used in stereo vision are described below. A depth refers to the distance between a camera and an object, matching refers to a process of determining that the location of an object displayed in a left picture is placed at what position in a right picture, and a disparity refers to a difference between coordinates appearing two images. A baseline distance refers to the distance between cameras, an Epipolar line refers to a line where an object, a plane including the lenses of two cameras, and an image plane cross each other, and a focal distance refers to the distance between an image and the lens. A visual field becomes narrow according to an increase in the focal distance, and a visual field becomes wide according to a decrease in the focal distance. For example, in stereo vision, the focal distance can be 4 mm to 8 mm.

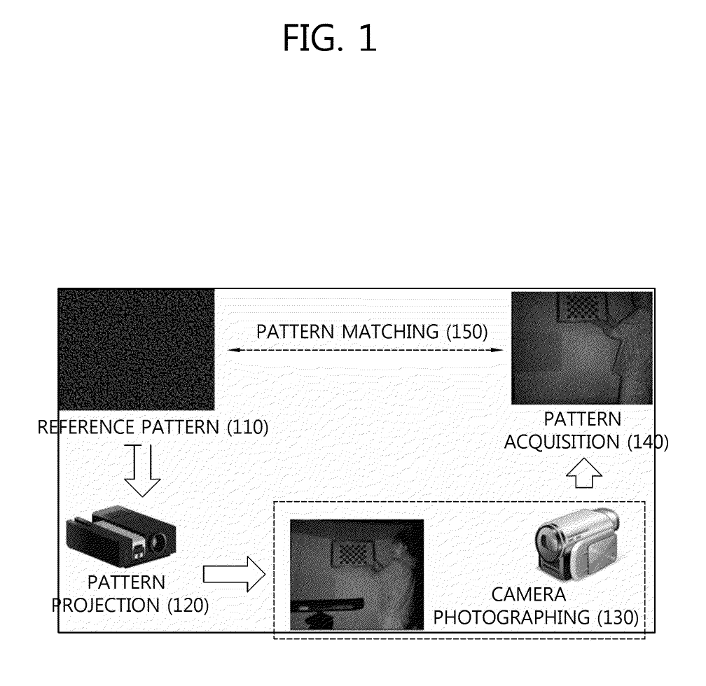

FIG. 1 shows an example of a conceptual diagram of stereo matching using a structured light method to which the present invention is applied. FIG. 1 shows an example of an operation of a vision machine configured to use stereo vision and to extract 3-D information by projecting structured light.

Referring to FIG. 1, the stereo matching method includes generating and storing a reference pattern, that is, a basis, at step 110, projecting the pattern onto the subject using a projector or a diffuser at step 120, photographing the projected subject at a point spaced apart from the projector (hereinafter referred to as a baseline) using a camera at step 130, extracting a pattern from the captured image at step 140, and calculating a disparity generated by the baseline by matching the reference pattern with a pattern photographed by a camera and converting the calculated disparity into 3-D information at step 150.

For example, the photographing of the camera at step 130 can be Infrared (IR) LED camera photographing, and the acquisition of the pattern at step 140 can be the acquisition of an IR LED pattern.

Furthermore, in order to obtain a 3-D having a wide field of view, a camera having a wider field of view can be used to photograph a widened pattern. For example, a field of view of the Kinect device which provides a 3-D precision scanning function can be a maximum of 57 degrees in width and a maximum of 43 degrees in height. The values correspond to a field of view for a pattern photographed by a camera and having relatively less distortion. Meanwhile, a horizontal field of view of a bright pattern having the 1^{st} order can be about 66 degrees or less, which may be inappropriate for an application apparatus that needs a wider field of view. In this case, pattern projection having a wide angle is necessary.

The projection of the pattern at step 120 is described in more detail below in order to improve a field of view of the pattern.

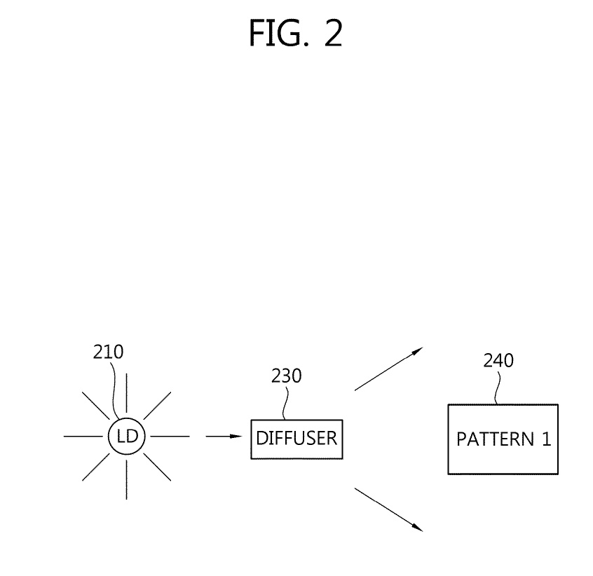

FIG. 2 shows an example of a method of projecting a pattern using a structured light method. FIG. 2 is a diagram showing a method of projecting a pattern using a structured light method including the Kinect device.

Referring to FIG. 2, elements for the pattern projection method can include a Laser Diode (LD) 210, a diffuser 230, and a projected pattern 240. Here, the LD 210 can be an LD suitable for the ITU-T G.651 standard, and the LD 210 can have the same wavelength as that used in an optical communication module and can be a light source having a 850 nm wavelength or less. The diffuser 230 is an optical diffusion device and can be a Diffraction Optical Element or a Diffraction Of Element (DOE) or a speckle pattern element. A DLP projector may be used as the diffuser 230.

While the LD 210 passes through the diffuser 230 the pattern 240 is projected onto the subject. More preferably, a spot pattern according to the DOE can be adopted in the Kinect device because it is advantageous to produce a pattern having a spot form whose image is focused by a laser by taking the intensity of a light source, the safety of a human being, and a success ratio of stereo matching into consideration.

Hereinafter, a pattern is assumed to be a pattern having a laser form using the DOE or the speckle element, but the scope of the present invention is not limited to the pattern using the DOE or the speckle element. For example, a pattern can be formed using a variety of elements, such as a DLP projector.

Meanwhile, an approaching method of widening a field of view by simply expanding a pattern in order to maintain 2-D resolution because 2-D resolution of a 3-D map increases as the distance between spots forming the pattern is narrowed can be used.

Furthermore, a single element that consumes power in FIG. 2 is the LD 210. It may be assumed that only one LD 210 is used in a system by taking low power into consideration. However, the scope of the present invention is not limited to only one LD, and a plurality of LD light sources may be used.

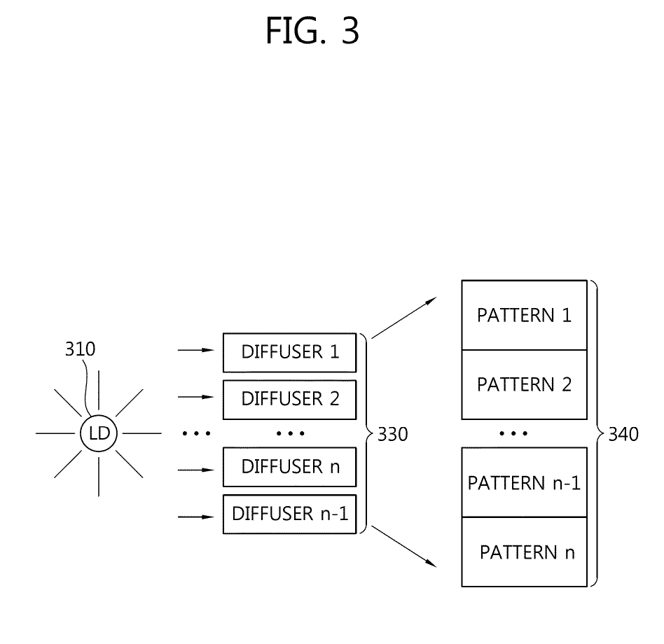

FIG. 3 shows another example of the method of projecting patterns using a structured light method. FIG. 3 shows a structure including a plurality of diffusers in the method of FIG. 2 in order to widen a pattern.

Referring to FIG. 3, elements for the pattern projection method include a Laser Diode (LD) 310, a plurality of diffusers 330, and a plurality of projected patterns 340. Here, the LD 310 can be an LD suitable for the ITU-T G.651 standard, and the LD 310 can have the same wavelength as that used in an optical communication module and can be a light source having a 850 nm wavelength or less. Each of the plurality of diffusers 330 is an optical diffusion device and can be a Diffraction Optical Element or a Diffraction Of Element (DOE) or a speckle pattern element. A DLP projector may be used as the diffuser 330.

If the plurality of diffusers 330 is used, it is not easy to arrange the diffusers 330 so that the light source of the LD 310 is uniformly distributed over the diffusers 330 because each diffuser has a fixed size. Meanwhile, if an LD is allocated to each diffuser for correct pattern projection, an increase in the cost of a system and a problem, such as the supply of power, can occur.

In order to solve the problems, there is a need for a method of using a single LD, maintaining the density of spots forming a pattern, and widening a field of view of the pattern.

To this end, there is a method of increasing a pattern, but this method has increased costs in a process technology and physical limits. Another method is to couple several diffusers. In the case of the Kinect device, a method of stacking diffusers so that one pattern is increased and copied to several patterns is used, but this method is problematic in that pattern matching is difficult because the patterns are distorted in a pin cushion form according to an increase in the distance from the center of the patterns.

A stereo vision apparatus and method having a wide angle using a structured light method in accordance with the present invention are described below. In order to widen a field of view of a pattern, an optical splitter is used.

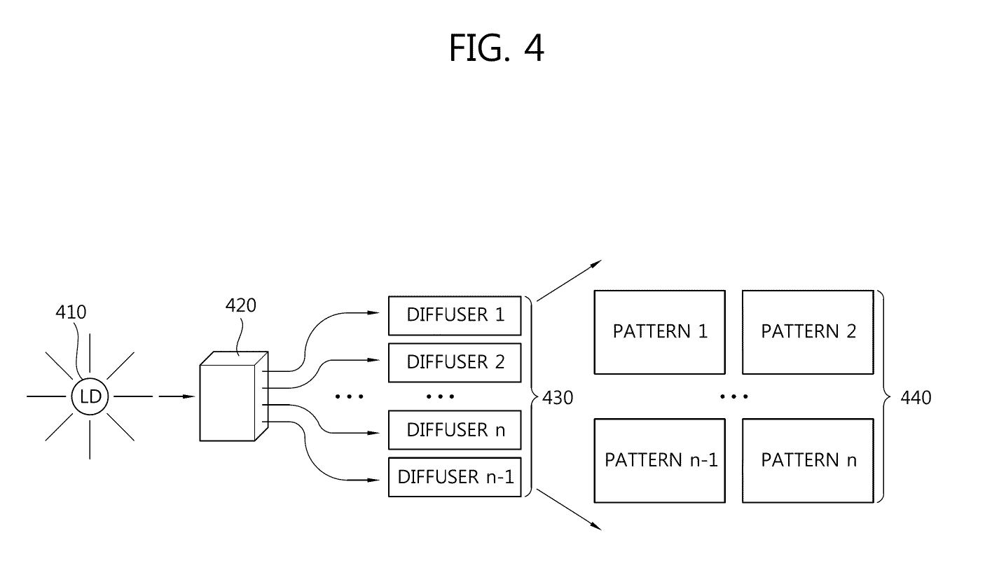

FIG. 4 shows an example of a stereo vision apparatus using a structured light method in accordance with the present invention. For example, the stereo vision apparatus can be a pattern projecting apparatus.

Referring to FIG. 4, the stereo vision apparatus can include an LD 410, an optical splitter 420, and a plurality of diffusers 430 or a plurality of projected patterns 440. Here, the LD 410 can be an LD suitable for the ITU-T G.651 standard, and the LD 410 can have the same wavelength as that used in an optical communication module and can be a light source having a 850 nm wavelength or less. Each of the plurality of diffusers 430 is an optical diffusion device and can be a Diffraction Optical Element or a Diffraction Of Element (DOE) or a speckle pattern element. A DLP projector may be used as the diffuser 430.

The optical splitter 420 is placed between the LD 410 and the plurality of diffusers 430 and configured to produce light sources for the diffusers 430. Copied LD light sources the number of which has been increased by the optical splitter 420 function as light sources for the respective diffusers 430.

Here, the optical splitter 420 is a passive element for outputting several light sources having the same characteristics as a received light source. The optical splitter 420 is a physical device without additional power consumption. If the optical splitter 420 is used, some losses can be generated in the intensity of a light source. In order to prevent matching performance from being affected, a method of controlling the intensity of a light source in a pattern matching step or a method of compensating for the intensity of the original LD light source by a lost ratio can be used.

The intensity of a light source lost by the optical splitter 420 apart from matching performance may function as an advantageous characteristic from a viewpoint of the eye safety of a laser pattern product. Here, the eye safety refers to a criterion indicating whether or not laser light is safe to an eye.

Furthermore, if the optical splitter 420 is used, there is an advantage in that the diffusers can be easily arranged.

It is not easy to correctly arrange the diffusers because it is not easy for the plurality of diffusers 330 of FIG. 3 to uniformly receive light from the LD 310, that is, one point light source. In contrast, the plurality of diffusers 430 of FIG. 4 can be arranged with a specific gap therebetween through the optical splitter 420 having output ports made of glass fiber, and the blocks of the projected patterns 440 can be freely combined.

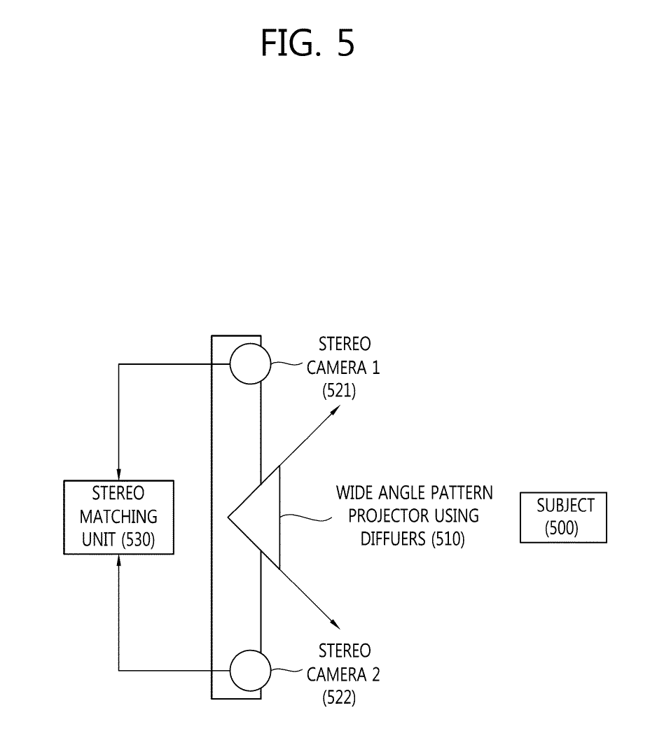

FIG. 5 shows an example of a stereo matching apparatus for matching a wide angle pattern in accordance with the present invention.

Referring to FIG. 5, a pattern projector 510 having a wide angle pattern having a wide field of view by a combination of a plurality of diffusers not a single diffuser can project patterns onto a subject 500 in a stereo vision system. The projected patterns are photographed by a stereo camera 1 521 and a stereo camera 2 522 having a wide field of view. A stereo matching unit 530 performs stereo matching on the photographed results of the stereo cameras 521 and 522. Accordingly, a 3-D depth map for the wide field of view can be obtained.

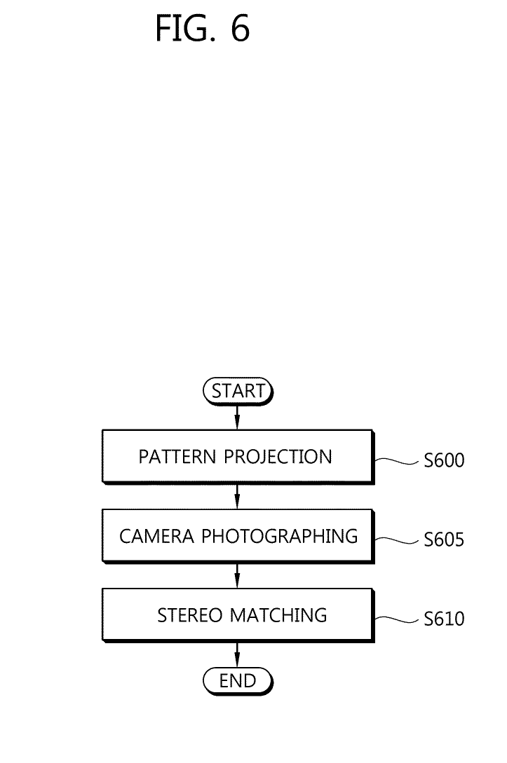

FIG. 6 shows an example of a stereo matching method for matching a wide angle pattern in accordance with the present invention.

Referring to FIG. 6, a stereo vision apparatus receives a light source from an LD, copies a plurality of light sources having the same characteristics as the light source of the LD, receives the copied light sources, and optically projects patterns onto the subject at step S600.

Next, the stereo vision apparatus photographs the patterns projected on the subject using a plurality of stereo cameras at step S605.

The stereo vision apparatus generates a depth map by performing stereo matching based on the photographed results at step S610.

In accordance with the present invention, the performance of pattern projection that generates distortion can be maintained, the projection region of a pattern can be widened at minimal cost, and a field of view of a stereo vision system can be widened.

In accordance with the present invention, a 3-D depth map having low power, low cost, and a wide field of view can be obtained, and the present invention can be used in fields of home appliances control, such as a game machine and TV, and a variety of space recognition fields, such as the recognition of environments and the recognition of things.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. A stereo vision apparatus, comprising
a Laser Diode (LD);
an optical splitter configured to receive a light source from the LD and copy a plurality of light sources having identical characteristics with the light source of the LD; and
a plurality of diffusers configured to receive the plurality of light sources copied by the optical splitter and optically project patterns.

2. The stereo vision apparatus of claim 1, wherein each of the plurality of diffusers comprises a Diffraction Optical Element (DOE) or a speckle pattern element.

3. The stereo vision apparatus of claim 1, wherein a wavelength of the light source of the LD is identical with a wavelength of an optical communication module.

4. The stereo vision apparatus of claim 1, further comprising a pattern matching unit configured to control or compensate for an intensity of the light source lost in the optical splitter.

5. The stereo vision apparatus of claim 1, wherein output ports of the optical splitter are made of glass fiber.

6. A method of a stereo vision apparatus projecting patterns, comprising:
receiving a light source from a Laser Diode (LD);
copying a plurality of light sources having identical characteristics with the light source of the LD; and
optically projecting patterns based on the copied light sources.

7. The method of claim 6, wherein copying the plurality of light sources is performed through Diffraction Optical Elements (DOEs) or speckle pattern elements.

8. The method of claim 6, wherein a wavelength of the light source of the LD is identical with a wavelength of an optical communication module.

9. The method of claim 6, further comprising controlling or compensating for an intensity of the light source lost when copying the plurality of light sources.

10. The method of claim 6, wherein projecting the patterns is performed through output ports made of glass fiber.

11. A stereo vision matching apparatus, comprising:
a pattern projector configured to comprise a Laser Diode (LD), an optical splitter for receiving a light source from the LD and copying a plurality of light sources having identical characteristics with the light source of the LD, and a plurality of diffusers for receiving the plurality of light sources copied by the optical splitter and optically projecting patterns onto a subject;
a plurality of stereo cameras configured to photograph the patterns projected on the subject; and
a stereo matching unit configured to generate a depth map by performing stereo matching based on the photographed results.

12. The stereo vision matching apparatus of claim 11, wherein each of the plurality of diffusers comprises a Diffraction Optical Element (DOE) or a speckle pattern element.

13. The stereo vision matching apparatus of claim 11, wherein a wavelength of the light source of the LD is identical with a wavelength of an optical communication module.

14. The stereo vision matching apparatus of claim 11, further comprising a pattern matching unit configured to control or compensate for an intensity of the light source lost in the optical splitter.

15. The stereo vision matching apparatus of claim 11, wherein output ports of the optical splitter are made of glass fiber.
